(19) United States
(12) Patent Application Publication
(10) Pub. No.: US 2011/0254873 A1
(43) Pub. Date: Oct. 20, 2011

(54) LIQUID CRYSTAL DISPLAY

(75) Inventors: MITSUYASU ASANO, Tokyo (JP); TOMOHIRO NISHI, Tokyo (JP); TAKESHI HIRAMATSU, Tokyo (JP); NAOKI IKAWA, Chiba (JP)

(73) Assignee: Sony Corporation, Tokyo (JP)

(21) Appl. No.: 13/070,965

(22) Filed: Mar. 24, 2011

(30) Foreign Application Priority Data
Apr. 16, 2010 (JP) 2010-095313

(51) Int. Cl. G09G 3/36; G09G 5/10

(52) U.S. Cl. 345/690; 345/90

(57) ABSTRACT

A liquid crystal display includes: a light source section including light-emission subsections controlled separately from one another; a liquid crystal display panel modulating, based on an input picture signal, light emitted from each light-emission subsection to display pictures; and a display control section including a partitioning-drive processing section which generates a light-emission pattern signal representing a two-dimensional pattern formed from lighting light-emission subsections and a partitioning-drive picture signal based on the input picture signal, the display control section performing a light-emission drive on each light-emission subsection based on the light-emission pattern signal and performing a display-drive on the liquid crystal display panel based on the partitioning-drive picture signal. The partitioning-drive processing section determines, based on the input picture signal, a barycentric position in a partitioned picture corresponding to each light-emission subsection, and generates the light-emission pattern signal and the partitioning-drive picture signal based on the barycentric position.

### BACKGROUND

The present disclosure relates to a liquid crystal display including a light source section which includes a plurality of light-emission subsections.

In recent years, as displays for flat-screen televisions and portable terminals, active matrix liquid crystal displays (LCDs) in which TFTs (Thin Film Transistors) are arranged for respective pixels are often used. In such liquid crystal displays, typically, pixels are individually driven by line-sequentially writing a picture signal to auxiliary capacitance elements and liquid crystal elements of the pixels from the top to the bottom of a screen.

As backlights used for the liquid crystal displays, backlights using cold cathode fluorescent lamps (CCFLs) as light sources are mainstream; however, in recent years, backlights using light emitting diodes (LEDs) have appeared.

As a liquid crystal display using such an LED or the like as a backlight, as described in Japanese Unexamined Patent Application Publication No. 2001-142409, there is proposed a liquid crystal display including a light source section which is divided into a plurality of light-emission subsections so that the light-emission subsections perform an light emission operation separately from one another (perform a divisional light emission operation). During such a divisional light emission operation, based on an input picture signal, a light-emission pattern signal representing a light-emission pattern for each of the light-emission subsections in the backlight and a partitioning-drive picture signal are generated.

### SUMMARY

In the case where pictures are displayed with use of such a divisional light emission operation, typically, a characteristic amount (such as a maximum pixel value) in each light-emission subsection is detected from an input picture signal, and a light-emission pattern signal is generated based on the characteristic amount in each light-emission subsection. In other words, light emission luminance of each light-emission subsection is determined with use of the characteristic amount of the input picture signal present in each light-emission subsection.

However, this technique has an issue that a temporal change in light emission luminance in adjacent light-emission subsections is noticeable depending on information (a pattern of an input picture) of an input picture signal to cause a decline in display image quality. In other words, in this technique, for example, in the case where motion pictures such as a small object with high luminance moving in a background with low luminance are displayed, light emission luminance is changed abruptly (in binary) in adjacent light-emission subsections along a time axis (an abrupt temporal change in light emission luminance occurs).

More specifically, for example, in the case where the above-described small object with high luminance moves across a boundary between adjacent light-emission subsections, before and after the small object crosses the boundary, switching between a light-on state and a light-off state in the adjacent light-emission subsections instantly take place. Therefore, in the case where such motion pictures are viewed specifically in a dark environment, such abrupt switching between the light-on state and the light-off state in the adjacent light-emission subsections is noticeable to cause a decline in display image quality.

It is desirable to provide a liquid crystal display allowed to improve display image quality when pictures are displayed with use of a light source section performing a divisional light emission operation.

According to an embodiment of the disclosure, there is provided a liquid crystal display including: a light source section including a plurality of light-emission subsections which are controlled separately from one another; a liquid crystal display panel modulating, based on an input picture signal, light emitted from each of the light-emission subsections in the light source section to display pictures; and a display control section including a partitioning-drive processing section which generates a light-emission pattern signal and a partitioning-drive picture signal based on the input picture signal, the light-emission pattern signal representing a two-dimensional pattern formed from lighting light-emission subsections in the light source section, the display control section performing a light-emission drive on each of the light-emission subsections in the light source section based on the light-emission pattern signal and performing a display-drive on the liquid crystal display panel based on the partitioning-drive picture signal. The partitioning-drive processing section determines, based on the input picture signal, a barycentric position in a partitioned picture corresponding to each of the light-emission subsections, and generates the light-emission pattern signal and the partitioning-drive picture signal based on the barycentric position in the partitioned picture.

In the liquid crystal display according to the embodiment of the disclosure, based on the input picture signal, the light-emission pattern signal representing a two-dimensional pattern formed from lighting the light-emission subsections in the light source section and the partitioning-drive picture signal are generated. Then, the light-emission drive is performed on each of the light-emission subsections in the light source section based on the light-emission pattern signal, and the display-drive is performed on the liquid crystal display panel based on the partitioning-drive picture signal. At this time, based on the input picture signal, a barycentric position in a partitioned picture corresponding to each of the light-emission subsections is determined. Then, the above-described light-emission pattern signal and the above-described partitioning-drive picture signal are generated based on the barycentric position in the partitioned picture. Therefore, for example, in the case where motion pictures such as a small object with high luminance moving in a background with low luminance are displayed, light emission luminance in adjacent light-emission subsections is changed smoothly along a time axis (a smooth temporal change in light emission luminance occurs). As a result, when motion pictures are displayed, a temporal change in light emission luminance in adjacent light-emission subsections is less noticeable.

In the liquid crystal display according to the embodiment of the disclosure, based on the input picture signal, the barycentric position in the partitioned picture corresponding to each of the light-emission subsections is determined, and the above-described light-emission pattern signal and the above-described partitioning-drive picture signal are generated based on the barycentric position in the partitioned picture; therefore, a temporal change in light emission luminance in adjacent light-emission subsections is allowed to be less noticeable. Therefore, when pictures are displayed with use of the light source section performing a divisional light emission operation, display image quality is allowed to be improved.

Other and further objects, features and advantages of the disclosure will appear more fully from the following description.

### BRIEF DESCRIPTION OF THE DRAWINGS

FIG. 1 is a block diagram illustrating a whole configuration of a liquid crystal display according to an embodiment of the disclosure.

FIG. 2 is a circuit diagram illustrating a specific configuration example of a pixel illustrated in FIG. 1.

FIG. 3 is a schematic exploded perspective view illustrating an example of a light emission sub-region and a divisional irradiated region in the liquid crystal display illustrated in FIG. 1.

FIG. 4 is a block diagram illustrating a specific configuration of a partitioning-drive processing section illustrated in FIG. 1.

FIG. 5 is a schematic view illustrating an outline of a divisional light emission operation of a backlight in the liquid crystal display illustrated in FIG. 1.

FIG. 6 is a schematic waveform chart for briefly describing the divisional light emission operation of the backlight in the liquid crystal display illustrated in FIG. 1.

FIG. 7 is a block diagram illustrating a configuration of a partitioning-drive processing section in a liquid crystal display according to a comparative example.

FIG. 8 is a schematic view illustrating an example of an input picture.

FIG. 9 is a waveform chart for describing a divisional light emission operation according to the comparative example when the input picture illustrated in FIG. 8 is displayed.

FIG. 10 is another waveform chart for describing the divisional light emission operation according to the comparative example when the input picture illustrated in FIG. 8 is displayed.

FIG. 11 is a schematic view for describing a method of determining a barycenter of a picture.

FIGS. 12A and 12B are plots illustrating examples of a gain characteristic line according to the embodiment.

FIGS. 13A and 13B are waveform charts for describing a divisional light emission operation according to the embodiment when the input picture illustrated in FIG. 8 is displayed.

FIG. 14 is a waveform chart specifically illustrating the divisional light emission operation illustrated in FIG. 13.

FIG. 15 is a block diagram illustrating a configuration of a partitioning-drive processing section according to a modification of the disclosure.

FIG. 16 is a plot illustrating an example of a gain characteristic line according to the modification.

FIG. 17 is a plot illustrating an example of a relationship between a variance value of position and a gradient of a gain characteristic line.

FIGS. 18A to 18C are schematic views illustrating a divisional light emission operation in a backlight according to another modification of the disclosure.

### DETAILED DESCRIPTION OF THE PREFERRED EMBODIMENTS

A preferred embodiment of the disclosure will be described in detail below referring to the accompanying drawings. Descriptions will be given in the following order.

1. Embodiment (Example in which a light-emission pattern signal is generated based on a barycentric position in a partitioned picture corresponding to each light emission sub-region)
2. Modification (Example in which a gain characteristic is adjusted in accordance with variance of position in picture)
3. Other modifications (Example using an edge-light type backlight, and the like)

### Embodiment

### Whole Configuration of Liquid Crystal Display 1

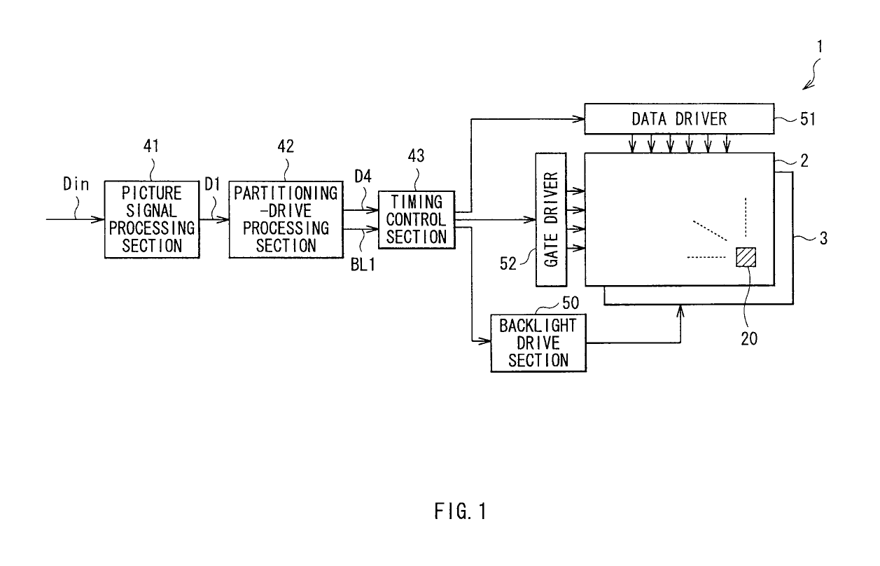

FIG. 1 illustrates a block diagram of a whole configuration of a liquid crystal display (a liquid crystal display 1) according to an embodiment of the disclosure.

The liquid crystal display 1 displays a picture based on an input picture signal Din applied from outside. The liquid crystal display 1 includes a liquid crystal display panel 2, a backlight 3 (a light source section), a picture signal processing section 41, a partitioning-drive processing section 42, a timing control section 43, a backlight drive section 50, a data driver 51 and a gate driver 52. The picture signal processing section 41, the partitioning-drive processing section 42, the timing control section 43, the backlight drive section 50, the data driver 51 and the gate driver 52 correspond to a specific example of “a display control section” in the disclosure.

The liquid crystal display panel 2 modulates light emitted from the backlight 3 which will be described later based on the input picture signal Din so as to display a picture based on the input picture signal Din. The liquid crystal display panel 2 includes a plurality of pixels 20 arranged in a matrix form as a whole.

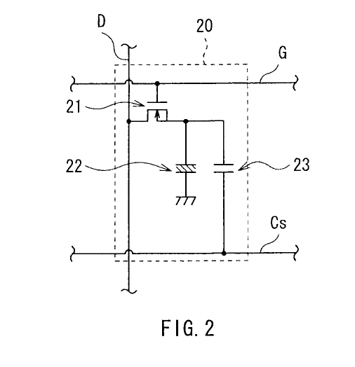

FIG. 2 illustrates a circuit configuration example of a pixel circuit in each pixel 20. The pixel 20 includes a liquid crystal element 22, a TFT element 21 and an auxiliary capacitance element 23. A gate line G for line-sequentially selecting a pixel to be driven, a data line D for supplying a picture voltage (a picture voltage supplied from the data driver 51) to the pixel to be driven and an auxiliary capacitance line Cs are connected to the pixel 20.

The liquid crystal element 22 performs a display operation in response to a picture voltage supplied from the data line D to one end thereof through the TFT element 21. The liquid crystal element 22 is configured by sandwiching a liquid crystal layer (not illustrated) made of, for example, a VA (Vertical Alignment) mode or TN (Twisted Nematic) mode liquid crystal between a pair of electrodes (not illustrated). One (one end) of the pair of electrodes in the liquid crystal element 22 is connected to a drain of the TFT element 21 and one end of the auxiliary capacitance element 23, and the other (the other end) of the pair of electrodes is grounded. The auxiliary capacitance element 23 is a capacitance element for stabilizing an accumulated charge of the liquid crystal element 22. One end of the auxiliary capacitance element 23 is connected to the one end of the liquid crystal element 22 and the drain of the TFT element 21, and the other end of the auxiliary capacitance element 23 is connected to the auxiliary capacitance line Cs. The TFT element 21 is a switching element for supplying a picture voltage based on a picture signal D1 to the one end of the liquid crystal element 22 and the one end of the auxiliary capacitance element 23, and is configured of a MOS-FET (Metal Oxide Semiconductor-Field Effect Transistor). A gate and a source of the TFT element 21 are connected to the gate line G and the data line D, respectively, and the drain of the TFT element 21 is connected to the one end of the liquid crystal element 22 and the one end of the auxiliary capacitance element 23.

The backlight 3 is a light source section applying light to the liquid crystal display panel 2, and includes, for example, a CCFL (Cold Cathode Fluorescent Lamp), an LED (Light Emitting Diode) or the like as a light-emitting element. As will be described later, the backlight 3 performs a light-emission drive according to information (a picture pattern) of the input picture signal Din.

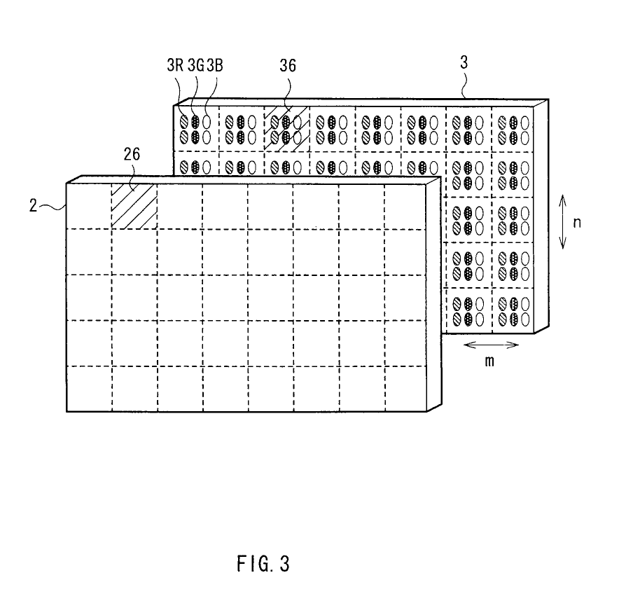

For example, as illustrated in FIG. 3, the backlight 3 includes a plurality of light emission sub-regions 36 (light-emission subsections) which are controlled separately from one another. In other words, the backlight 3 is configured of a partitioning-drive system backlight. More specifically, the backlight 3 includes a plurality of light emission sub-regions 36 by two-dimensionally arranging a plurality of light sources. Therefore, the backlight 3 is divided into n (vertical)×m (horizontal)=K light emission regions (n and m each are an integer of 2 or more) in an in-plane direction. Note that the number of the light emission regions is lower than the resolution of the pixels 20 in the above-described liquid crystal display panel 2. Moreover, as illustrated in FIG. 3, the liquid crystal display panel 2 includes a plurality of divisional irradiated regions 26 corresponding to the light emission sub-regions 36, respectively.

The backlight 3 is allowed to independently control light emission of the light emission sub-regions 36 based on the information (the picture pattern) of the input picture signal Din. Moreover, each of the light sources in the backlight 3 is configured of a combination of a red LED 3R emitting red light, a green LED 3G emitting green light and a blue LED 3B emitting blue light. However, the kind of LED used as the light source is not limited thereto, and, for example, a white LED emitting white light may be used. Note that one or more light sources of such a kind are arranged in each of the light emission sub-regions 36.

The picture signal processing section 41 performs, for example, predetermined image processing (such as a sharpness process or a gamma correction process) for an improvement in image quality on the input picture signal Din including pixel signals of the pixels 20 so as to generate the picture signal D1.

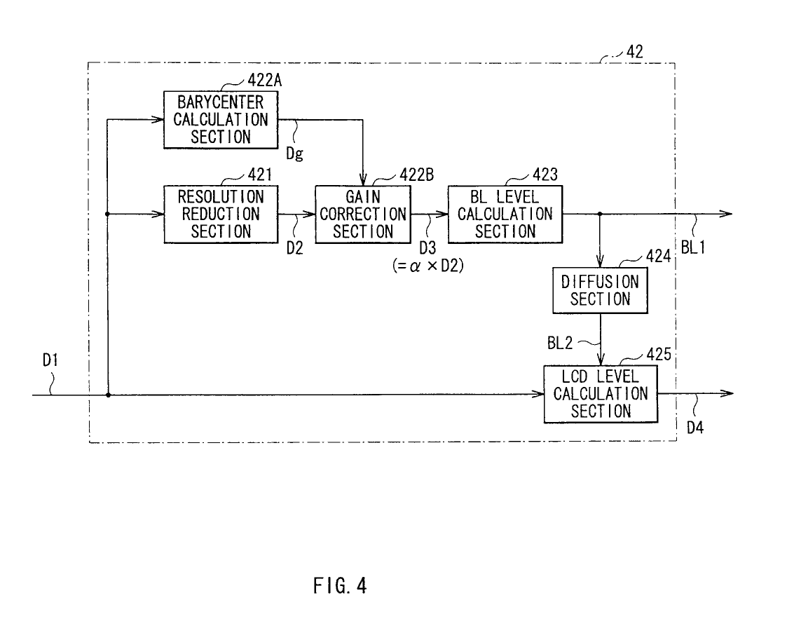

The partitioning-drive processing section 42 performs predetermined partitioning-drive processing on the picture signal D1 supplied from the picture signal processing section 41. Therefore, a light-emission pattern signal BL1 representing a light-emission pattern for each light emission sub-region 36 in the backlight 3 and a partitioning-drive picture signal D4 are generated. More specifically, the partitioning-drive processing section 42 determines a barycentric position (barycentric position data Dg which will be described later) in a partitioned picture corresponding to each light emission sub-region 36 based on the picture signal D1 to generate the light-emission pattern signal BL1 and the partitioning-drive picture signal D4 based on the barycentric position in the partitioned picture. Note that a specific configuration of the partitioning-drive processing section 42 will be described later (refer to FIG. 4).

The timing control section 43 controls drive timings of the backlight drive section 50, the gate driver 52 and the data driver 51, and supplies, to the data driver 51, the partitioning-drive picture signal D4 supplied from the partitioning-drive processing section 42.

The gate driver 52 line-sequentially drives the pixels 20 in the liquid crystal display panel 2 along the above-described gate line G in response to timing control by the timing control section 43. On the other hand, the data driver 51 supplies, to each of the pixels 20 of the liquid crystal display panel 2, a picture voltage based on the partitioning-drive picture signal D4 supplied from the timing control section 43. More specifically, the data driver 51 performs D/A (digital/analog) conversion on the partitioning-drive picture signal D4 to generate a picture signal (the above-described picture voltage) as an analog signal to output the analog signal to each of the pixels 20. Therefore, a display-drive based on the partitioning-drive picture signal D4 is performed on the liquid crystal display panel 2.

The backlight drive section 50 performs a light-emission drive (a lighting drive) on each of the light emission sub-regions 36 in the backlight 3 based on the light-emission pattern signal BL1 supplied from the partitioning-drive processing section 42 in response to timing control by the timing control section 43.

Specific Configuration of Partitioning-Drive Processing Section 42

Next, referring to FIG. 4, a specific configuration of the partitioning-drive processing section 42 will be described below. FIG. 4 illustrates a block diagram of the partitioning-drive processing section 42. The partitioning-drive processing section 42 includes a resolution reduction section 421, a barycenter calculation section 422A, a gain correction section 422B, a BL level calculation section 423, a diffusion section 424 and an LCD level calculation section 425.

The resolution reduction section 421 performs a predetermined resolution reduction process on the picture signal D1 to generate a picture signal D2 (a lowered-resolution picture signal) as a base of the above-described light-emission pattern signal BL1. More specifically, the resolution reduction section 421 reconfigures the picture signal D1 configured of a luminance level signal (a pixel signal) for each of the pixels 20 into a luminance level signal for each of the light emission sub-regions 36 of which number is lower than the resolution of the pixels 20 so as to generate a picture signal D2. At this time, the resolution reduction section 421 reconfigures the picture signal D1 by extracting a predetermined characteristic amount (such as a maximum value or an average value of a luminance level or a composite value thereof) from a plurality of pixel signals in each of the light emission sub-regions 36.

The barycenter calculation section 422A determines the barycentric position data Dg which is data representing a barycentric position in a partitioned picture corresponding to each light emission sub-region 36 based on the picture signal D1. More specifically, the barycenter calculation section 422A performs calculation of the barycentric positions of pixel signals in the divisional irradiated regions 26 corresponding to the light emission sub-regions 36, respectively, with use of a predetermined expression which will be described later. Note that a specific operation of the barycenter calculation section 422A will be described later.

The gain correction section 422B performs a predetermined gain correction on the picture signal D2 supplied from the resolution reduction section 421 with use of the barycentric position data Dg supplied from the barycenter calculation section 422A to generate a picture signal D3 as the resultant of such a gain correction. As will be described later, a gain α in the gain correction is determined in accordance with a barycentric position in a partitioned picture corresponding to each light emission sub-region 36 determined by the barycentric position data Dg. More specifically, the gain correction section 422B performs a gain correction with use of the following expression (1) to generate the picture signal D3. Note that a specific operation of the gain correction section 422B will be described later.

D3=α×D2 (1)

The BL level calculation section 423 determines a light emission luminance level in each of the light emission sub-regions 36 based on the picture signal D3 supplied from the gain correction section 422B to generate the light-emission pattern signal BL1 representing a light-emission pattern for each of the light emission sub-regions 36. More specifically, a light-emission pattern according to the luminance level in each region is obtainable by analyzing the luminance level of the picture signal D3 for each of the light emission sub-regions 36.

The diffusion section 424 performs a predetermined diffusion process on the light-emission pattern signal BL1 supplied from the BL level calculation section 423 to output a light-emission pattern signal BL2 as the resultant of the diffusion process to the LCD level calculation section 425, and converts a signal for each of the light emission sub-regions 36 to a signal for each of the pixels 20. The diffusion process is a process performed in consideration of a luminance distribution (a diffusion distribution of light from a light source) in an actual light source (in this case, an LED of each color) in the backlight 3.

The LCD level calculation section 425 generates the partitioning-drive picture signal D4 based on the picture signal D1 and the light-emission pattern signal BL2 as the resultant of the diffusion process. Specifically, the signal level of the picture signal D1 is divided by the light-emission pattern signal BL2 as the resultant of the diffusion process to generate the partitioning-drive picture signal D4. More specifically, the LCD level calculation section 425 generates the picture signal D4 with use of the following expression (2).

D4=(D1/BL2) (2)

In this case, a relationship of an original signal (the picture signal D1)=(the light-emission pattern signal BL2×the partitioning-drive picture signal D4) is obtained by the above-described expression (2). In the relationship, (the light-emission pattern signal BL2×the partitioning-drive picture signal D4) physically means that an image based on the partitioning-drive picture signal D4 is superimposed on an image in each light emission sub-region 36 in the backlight 3 emitting light with a certain light-emission pattern. Therefore, as will be described in detail later, bright and dark distributions of transmitted light in the liquid crystal display panel 2 are cancelled out, and viewing a picture formed by superimposing the images is equivalent to viewing original display (display based on an original signal).

Functions and Effects of Liquid Crystal Display 1

Next, functions and effects of the liquid crystal display 1 according to the embodiment will be described below.

1. Brief Description of Divisional Light Emission Operation

In the liquid crystal display 1, as illustrated in FIG. 1, first, the picture signal processing section 41 performs predetermined image processing on the input picture signal Din to generate the picture signal D1. Next, the partitioning-drive processing section 42 performs a predetermined partitioning-drive process on the picture signal D1. Therefore, the light-emission pattern signal BL1 representing a light-emission pattern for each of the light emission sub-regions 36 in the backlight 3 and the partitioning-drive picture signal D4 are generated.

Next, the partitioning-drive picture signal D4 and the light-emission pattern signal BL1 generated in such a manner are supplied to the timing control section 43. The partitioning-drive picture signal D4 is supplied from the timing control section 43 to the data driver 51. The data driver 51 performs D/A conversion on the partitioning-drive picture signal D4 to generate a picture voltage which is an analog signal. Then, a display-drive operation is performed by a drive voltage supplied from the gate driver 52 and the data driver 51 to each of the pixels 20. Therefore, a display-drive based on the partitioning-drive picture signal D4 is performed on the liquid crystal display panel 2.

More specifically, as illustrated in FIG. 2, ON/OFF operations of the TFT element 21 are switched in response to a selection signal supplied from the gate driver 52 through the gate line G. Therefore, conduction is selectively established between the data line D and the liquid crystal element 22 and the auxiliary capacitance element 23. As a result, a picture voltage based on the partitioning-drive picture signal D4 supplied from the data driver 51 is supplied to the liquid crystal element 22, and a line-sequential display-drive operation is performed.

On the other hand, the light-emission pattern signal BL1 is supplied from the timing control section 43 to the backlight drive section 50. The backlight drive section 50 performs a light-emission drive (a partitioning-drive operation) on each of the light emission sub-regions 36 in the backlight 3 based on the light-emission pattern signal BL1.

At this time, in the pixels 20 to which the picture voltage is supplied in such a manner, illumination light from the backlight 3 is modulated in the liquid crystal display panel 2 to be emitted as display light. Thus, a picture based on the input picture signal Din is displayed on the liquid crystal display 1.

More specifically, for example, as illustrated in FIG. 5, a composite image 73 formed by physically superimposing (multiplicatively combining) a light-emission plane image 71 by each of the light emission sub-regions 36 of the backlight 3 and a panel plane image 72 only by the liquid crystal display panel 2 on each other is a picture eventually viewed on a whole liquid crystal display 1.

Moreover, in the case where the picture signal D1 supplied to the partitioning-drive processing section 42 represents a still picture in which a small bright object is present in a dark (gray-level) background as a whole, the divisional light emission operation is performed in the following manner.

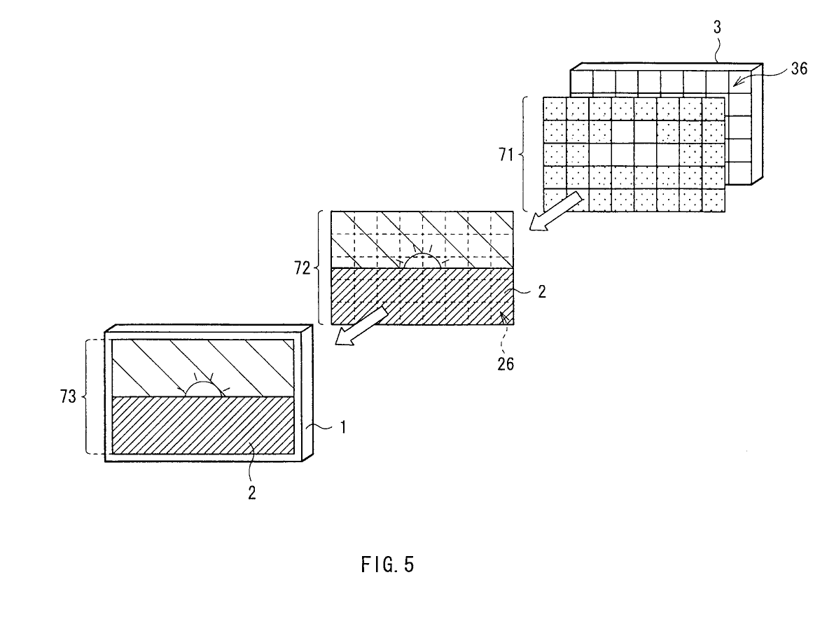

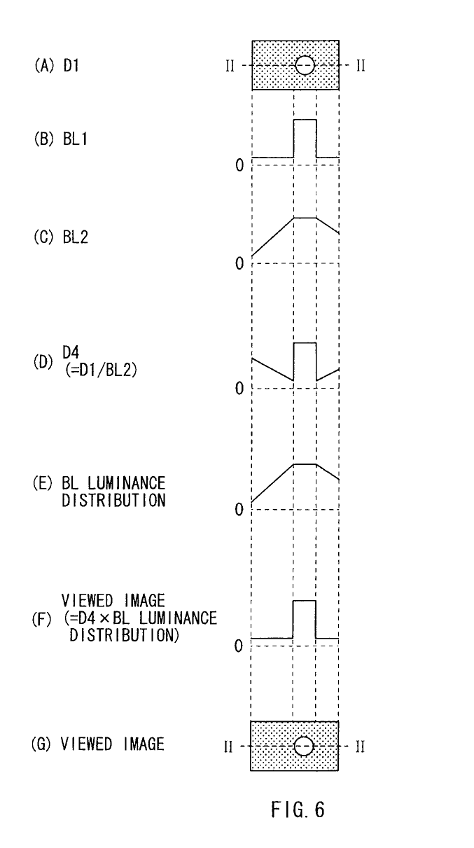

FIG. 6 schematically illustrates the divisional light emission operation in the liquid crystal display 1 in this case with a timing chart. In FIG. 6, parts (A), (B), (C) and (D) illustrate the picture signal D1, the light-emission pattern signal BL1, the light-emission pattern signal BL2 and the partitioning-drive picture signal D4 (=D1/BL2), respectively. Moreover, a part (E) indicates an actual luminance distribution (a BL luminance distribution) in the backlight 3, and parts (F) and (G) indicate an actually viewed image (=D4×BL luminance distribution). Note that in the parts (B) to (F), a horizontal axis indicates a pixel position in a horizontal direction along a line II-II in the parts (A) and (G). Moreover, in the parts (A) and (G), a vertical axis indicates a pixel position in a vertical direction in a screen, and in the parts (B) to (F), a vertical axis indicates a level axis. It is obvious from FIG. 6 that the information (an image) of the supplied picture signal D1 and the viewed image are the same as each other when a picture is displayed with use of the divisional light emission operation.

2. Operation of Generating Light-Emission Pattern Signal

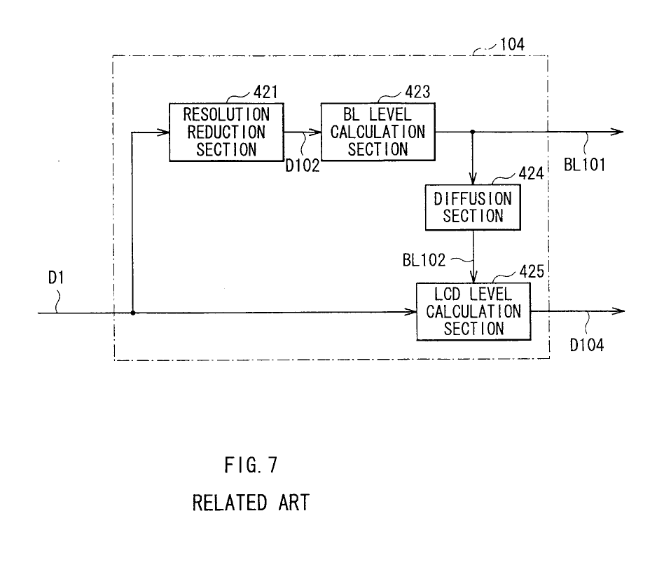

Next, referring to FIGS. 7 to 14, as one of characteristic parts of the disclosure, an operation of generating the light-emission pattern signal BL1 in the partitioning-drive processing section 42 will be described in detail below in comparison with a comparative example.

### 2-1. Comparative Example

FIG. 7 illustrates a block diagram of a partitioning-drive processing section (a partitioning-drive processing section 104) in a liquid crystal display according to a comparative example. The partitioning-drive processing section 104 in the comparative example has the same configuration as that of the partitioning-drive processing section 42 in the embodiment illustrated in FIG. 4, except that the barycenter calculation section 422A and the gain correction section 422B are removed (not arranged).

In the partitioning-drive processing section 104, first, the resolution reduction section 421 performs a resolution reduction process on the picture signal D1 to generate a picture signal D102. Next, the BL level calculation section 423 generates a light-emission pattern signal BL101 representing a light-emission pattern for each of the light emission sub-regions 36 based on the picture signal D102. Moreover, the diffusion section 424 performs a diffusion process on the light-emission pattern signal BL101 supplied from the BL level calculation section 423 to output a light-emission pattern signal BL102 as the resultant of the diffusion process to the LCD level calculation section 425. Then, the LCD level calculation section 425 generates a partitioning-drive picture signal D104 based on the picture signal D1 and the light-emission pattern signal BL102 as the resultant of the diffusion process. More specifically, as in the case of the embodiment, the LCD level calculation section 425 generates the picture signal D104 with use of the following expression (3).

D104=(D1/BL102) (3)

Thus, in the partitioning-drive processing section 104 in the comparative example, the resolution reduction section 421 detects a characteristic amount (such as a maximum pixel value) in each of the light emission sub-regions 36 from the picture signal D1 to generate the picture signal D102 as a lowered-resolution picture signal. Then, the BL level calculation section 423 generates the light-emission pattern signal BL1 based on the characteristic amount in each of the light emission sub-regions 36. In other words, unlike the embodiment which will be described below, light emission luminance of each of the light emission sub-regions 36 is determined with use of a luminance level of a pixel signal present in each of the light emission sub-regions 36.

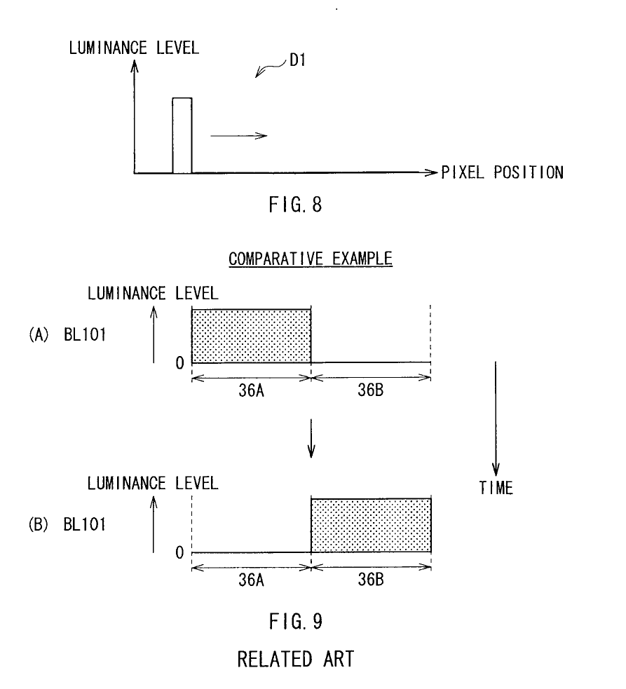

However, in such a technique of the comparative example, as will be described below, a temporal change in light emission luminance in adjacent light emission sub-regions 36 is noticeable depending on information (a pattern of an input picture) of the picture signal D1 to cause a decline in display image quality. More specifically, for example, in the case where motion pictures such as a small object with high luminance moving in a dark (black-level) background as a whole as in the case of the picture signal D1 illustrated in FIG. 8 are displayed, light emission luminance is changed abruptly (in binary) in adjacent light emission sub-regions 36 along a time axis. In other words, an abrupt temporal change in light emission luminance in adjacent light emission sub-regions 36 occurs.

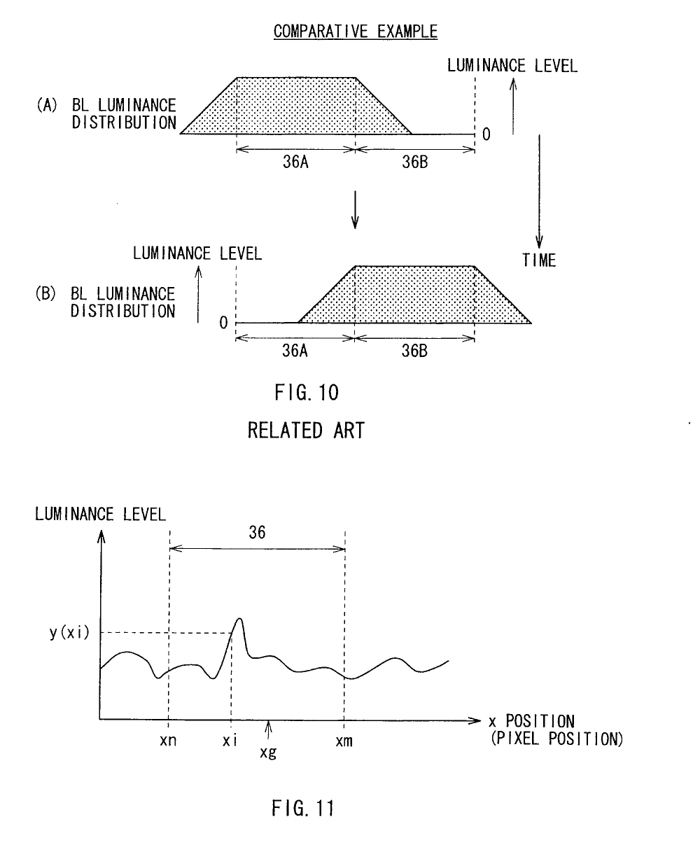

The temporal change will be described as below referring to FIGS. 9 and 10. Parts (A) and (B) in FIG. 9 illustrate a temporal change in the waveform of a light-emission pattern BL101 in two adjacent light emission sub-regions 36A and 36B during the divisional light emission operation in the comparative example in the case where the picture signal D1 configured of motion pictures illustrated in FIG. 8 is supplied. On the other hand, parts (A) and (B) in FIG. 10 illustrate a temporal change in a luminance distribution of the backlight 3 in the comparative example in the two adjacent light emission sub-regions 36A and 36B in this case.

In the comparative example, as described above, the light emission luminance of each of the light emission sub-regions 36 is determined with use of only a pixel signal present in each of the light emission sub-regions 36. Therefore, in the case where the picture signal D1 configured of motion pictures illustrated in FIG. 8 is supplied, light emission luminance in each of the light emission sub-regions 36A and 36B is determined by whether the above-described small object with high luminance is present or not in each of the light emission sub-regions 36A and 36B, and the light emission luminance is switched in binary (between “0” and a certain value) depending on the movement of the small object. In other words, as illustrated in FIGS. 9 and 10, when the small object with high luminance moves across a boundary between the two adjacent light emission sub-regions 36A and 36B, before and after the small object crosses the boundary, switching between a light-on and a light-off state in the light emission sub-regions 36A and 36B instantly takes place. Therefore, in the case where such motion pictures are viewed specifically in a dark environment, such abrupt switching between the light-on state and the light-off state in the adjacent light emission sub-regions 36A and 36B is noticeable to cause a decline in display image quality.

### 2-2. Embodiment

On the other hand, in the embodiment, in the partitioning-drive processing section 42, the barycenter calculation section 422A determines the barycentric position data Dg as data representing the barycentric position in a partitioned picture corresponding to each light emission sub-region 36 based on the picture signal D1. Moreover, the resolution reduction section 421 performs a predetermined resolution reduction process on the picture signal D1 to generate the picture signal D2 as the lowered-resolution picture signal. Next, the gain correction section 422B performs a predetermined gain correction on the picture signal D2 with use of the barycentric position data Dg to generate the picture signal D3 as the resultant of the gain correction. Then, in the BL level calculation section 423, the diffusion section 424 and the LCD level calculation section 425, the light-emission pattern signal BL and the partitioning-drive picture signal D4 are generated based on the picture signal D3 as the resultant of the gain correction. In other words, the partitioning-drive processing section 42 in the embodiment determines the barycentric position data Dg representing the barycentric position in the partitioned picture corresponding to each light emission sub-region 36 based on the picture signal D1 to generate the light-emission pattern signal BL1 and the partitioning-drive picture signal D4 based on the barycentric position data Dg in the partitioned picture. The divisional light emission operation in the embodiment will be described in detail below.

First, the barycenter calculation section 422A determines, based on the picture signal D1, the barycentric position of a pixel signal in each of the divisional irradiated regions 26 corresponding to the light emission sub-regions 36, respectively, with use of the following expressions (4) to (7). More specific description will be given as below referring to FIG. 11. In the expressions, a pixel position (x position) in a horizontal direction (an H direction) of a target pixel in a certain light emission sub-region 36 is xi, a pixel value of the pixel in the pixel position x=xi is y(xi), the minimum value and the maximum value of the x position in the light emission sub-region 36 are xn and xm, and a barycentric position in a partitioned picture corresponding to the light emission sub-region 36 is xg.

In the case where a result of adding pixel values (luminance levels) y(xi) in all pixels 20 in the light emission sub-region 36 is S1, the result S1 is represented by the following expression (4). Next, in the case where a result of adding results of multiplying the x position xi and the luminance level y(xi) in all pixels 20 in the light emission sub-region 36 is S2, the result S2 is represented by the following expression (5). A relationship between the results S1 and S2 and the barycentric position xg in the partitioned picture is represented by the following expression (6). Therefore, the barycentric position xg in the partitioned picture is determined by the following expression (7) which is a conversion of the expression (6). In other words, the barycentric position xg in the partitioned picture corresponding to each light emission sub-region 36 is determined by dividing the result S2 determined by the expression (5) by the result S1 determined by the expression (4). Note that a method of determining the barycentric position of the x position in the horizontal direction (the H direction) in the liquid crystal display panel 2 is described herein; however, the barycentric position of a y position in a vertical direction (a V direction) is allowed to be determined in the same manner.

$$\begin{matrix}S 1 = {\sum }_{i = n}^{m} y ( xi ) & ( 4 ) \\ S 2 = {\sum }_{i = n}^{m} \{ y ( xi ) \times xi \} & ( 5 ) \\ ( S 1 \times xg ) = S 2 & ( 6 ) \\ xg = ( S 2 / S 1 ) & ( 7 )\end{matrix}$$

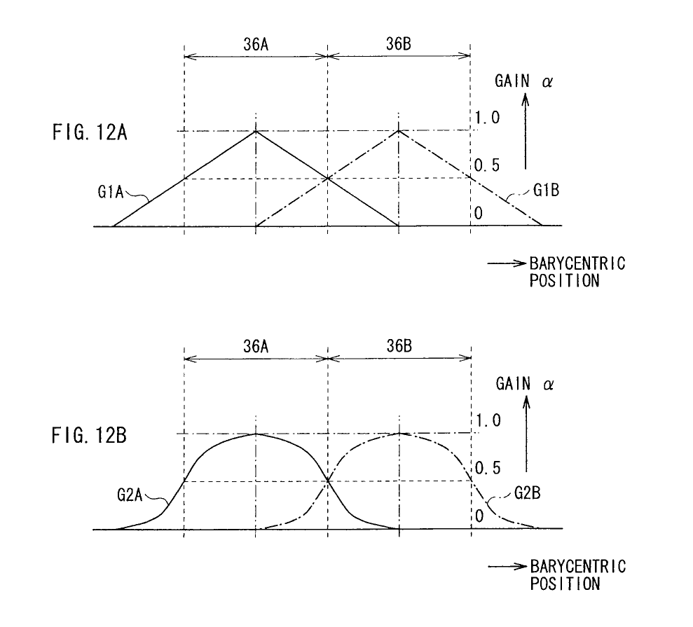

Next, the gain correction section 422B performs a predetermined gain correction determined by the above-described expression (1) on the picture signal D2 for each light emission sub-region 36 with use of the barycentric position data Dg determined in such a manner to generate the picture signal D3 as the resultant of the gain correction. In this case, as illustrated in FIGS. 12A and 12B, a gain a in the gain correction is determined in accordance with the barycentric position in a partitioned picture corresponding to each light emission sub-region 36 determined by the barycentric position data Dg. In FIGS. 12A and 12B, gain characteristics (gain functions) G1A and G2A representing a relationship between the barycentric position and the value of the gain α represent gain characteristics in the light emission sub-region 36A, and gain characteristics G1B and G2B represent gain characteristics in the light emission sub-region 36B. Note that actual gain characteristics are two-dimensionally determined in the horizontal direction (the H direction, an x direction) and the vertical direction (the V direction, a y direction); however, for easy description, gain characteristics along one direction (for example, the horizontal direction) will be described below.

As illustrated in FIGS. 12A and 12B, in each of the gain characteristics (gain functions) G1A, G2A, G1B and G2B, the value of the gain α decreases as the barycentric position goes away from a center of the light emission sub-region 36A or 36B. More specifically, the value of the gain α is 1.0 at the center of each of the light emission sub-regions 36A and 36B, and is 0.5 at a boundary between adjacent light emission sub-regions 36A and 36B. Moreover, in these gain characteristics G1A, G2A, G1B and G2B, even though the barycentric position is located outside a corresponding light emission sub-region, the value of the gain α is not 0 but a value (>0) determined by the gain characteristics.

Note that in FIG. 12A, each of the gain characteristics G1A and G1B is determined by a straight line (a gain characteristic line is straight), but the shape of the gain characteristic is not limited thereto. In other words, for example, as in the case of the gain characteristics G2A and G2B illustrated in FIG. 12B, each of the gain characteristics may be determined by a curved line (in this case, a S-curved line) (the gain characteristic line may be curved). Further, an example in which the gain α is 1.0 at the center of each light emission sub-region, and 0.5 at the boundary between adjacent light emission sub-regions is illustrated herein; however, the value of the gain α with respect to the barycentric position is not limited thereto. Such gain characteristics are set in consideration of, for example, a luminance distribution of the backlight 3, or the like; however, in actual use, use of the gain characteristics determined by, for example, straight lines as illustrated in FIG. 12A does not cause an issue.

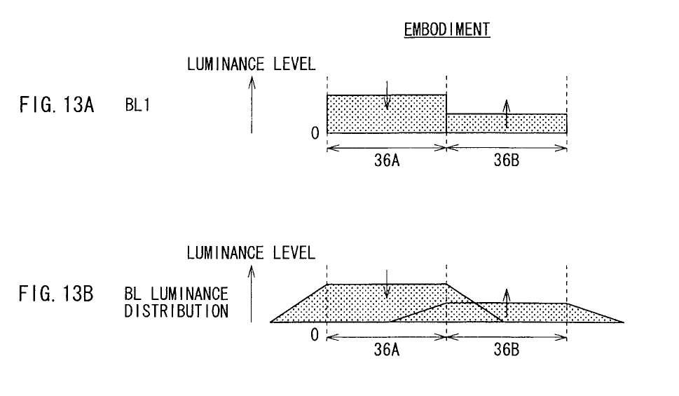

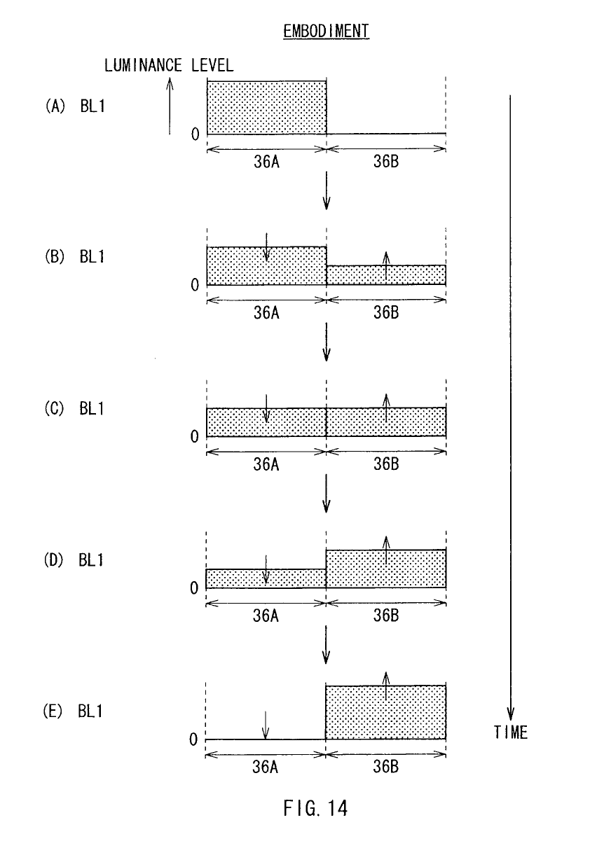

Next, based on the picture signal D3 as the resultant of the gain correction using such a gain α, the light-emission pattern signal BL and the partitioning-drive picture signal D4 are generated. Therefore, for example, as described above referring to FIG. 8, in the case where motion pictures such as the small object with high luminance moving in a dark (black level) background as a whole are displayed, unlike the above-described comparative example, the divisional light emission operation in the embodiment is performed in the following manner. As indicated by arrows in FIGS. 13A and 13B and parts (A) to (E) in FIG. 14, light emission luminance in the adjacent light emission sub-regions 36A and 36B is changed smoothly along a time axis (a smooth temporal change in light emission luminance occurs). As a result, in the embodiment, when motion pictures are displayed, compared to the above-described comparative example, a temporal change in light emission luminance in the adjacent light emission sub-regions 36A and 36B is less noticeable. Note that in this case, in a luminance distribution of the backlight illustrated in FIG. 13B, luminance distributions of two adjacent light emission sub-regions 36A and 36B are combined.

As described above, in the embodiment, in the partitioning-drive processing section 42, the barycentric position (the barycentric position data Dg) in the partitioned picture corresponding to each of the light emission sub-regions 36 is determined based on the picture signal D1, and the light-emission pattern signal BL1 and the partitioning-drive picture signal D4 are generated based on the barycentric position in the partitioned picture; therefore, when motion pictures are displayed, a temporal change in light emission luminance in the adjacent light emission sub-regions 36 is allowed to be less noticeable. Therefore, when pictures are displayed with use of a light source section performing a divisional light emission operation, display image quality is allowed to be improved. Moreover, when the divisional light emission operation is performed, as in the case of the divisional light emission operation in related art, a reduction in power consumption and an improvement in black luminance are achievable.

Modification

Next, a modification of the above-described embodiment will be described below. Note that like components are denoted by like numerals as of the above-described embodiment and will not be further described.

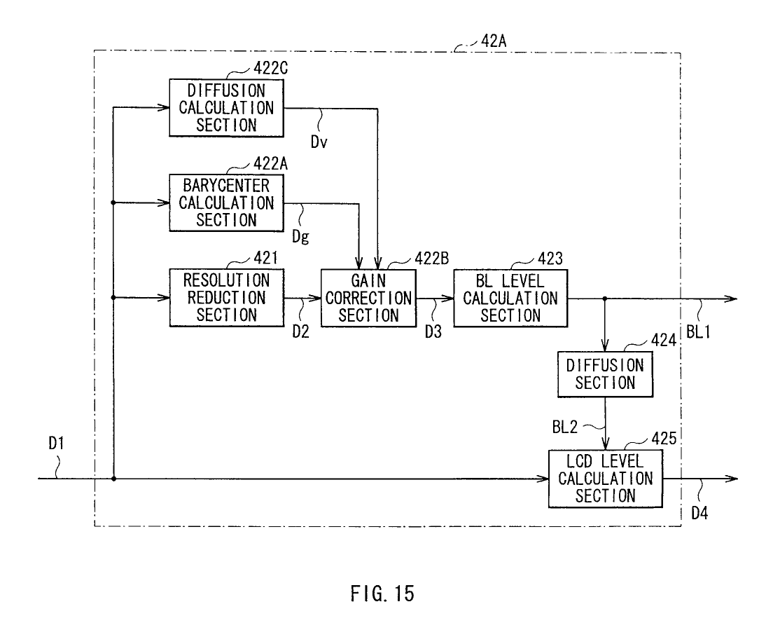

FIG. 15 illustrates a block diagram of a partitioning-drive processing section (a partitioning-drive processing section 42A) in a liquid crystal display according to the modification. As will be described later, the partitioning-drive processing section 42A in the modification has a configuration in which the partitioning-drive processing section 42 in the embodiment illustrated in FIG. 4 further includes a diffusion calculation section 422C determining a variance value of position in picture. Therefore, in the modification, the light-emission pattern signal BL1 is generated with use of the variance value of position in picture in addition to the barycentric position in the partitioned picture described in the above embodiment.

The diffusion calculation section 422C determines a variance value Dv of position in picture for each of partitioned pictures corresponding to the light emission sub-regions 36 based on the picture signal D1. More specifically, the diffusion calculation section 422C determines the variance value Dv of position by the following expression (8) determined with use of, for example, the barycentric position xg determined by the above-described expression (7) and the result S1 determined by the expression (4).

$$Dv = \frac{{\sum }_{i = n}^{m} \{ {( xi - xg )}^{2} \times y ( xi ) \}}{S 1} \qquad ( 8 )$$

Moreover, the gain correction section 422B in the modification performs a gain correction on the picture signal D2 supplied from the resolution reduction section 421 with use of the variance value Dv of position supplied from the diffusion calculation section 422C in addition to the barycentric position data Dg supplied from the barycenter calculation section 422A to generate the picture signal D3 as the resultant of the gain correction. Then, the BL level calculation section 423 generates the light-emission pattern signal BL1 based on the picture signal D3 as the resultant of the gain correction generated in such a manner.

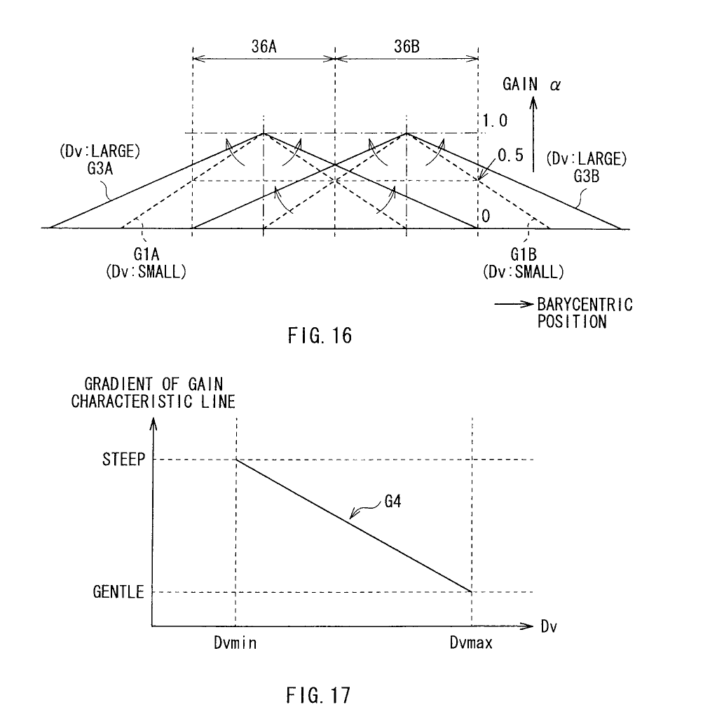

More specifically, for example, as illustrated in FIG. 16, the gain correction section 422B determines the value of the gain α in the gain correction in accordance with the barycentric position determined by the barycentric position data Dg and the variance value Dv of position. In other words, in this case, as illustrated by arrows in FIG. 16, the gradients of gain characteristic lines representing the gain characteristics G1A and G1B are adjusted in accordance with the variance value Dv of position (refer to gain characteristics G3A and G3B in the drawing). More specifically, the gradients of gain characteristic lines are allowed to be steeper as the variance value Dv of position decreases. On the other hand, the gradients of the gain characteristic lines are allowed to be gentler as the variance value Dv of position increases. More specifically, for example, as in the case of a characteristic G4 illustrated in FIG. 17, the gradient of each of the above-described gain characteristic lines linearly decreases as the variance value Dv of position increases from a minimum value Dvmin to a maximum value Dvmax. However, a relationship between the variance value Dv of position and the gradient of the gain characteristic line is not limited to that illustrated in FIG. 17 (a line represented by the characteristic G4), and may exhibit, for example, a curved change.

Thus, in the modification, the light-emission pattern signal BL1 is generated with use of the variance value Dv of position in picture in addition to the barycentric position in the partitioned picture described in the above-described embodiment, because of the following reason. First, in the above-described embodiment, a gain correction is performed without consideration of the variance value Dv of position in picture; therefore, as long as the barycentric position in the partitioned picture is the same, for example, in both of the case where signals are concentrated in one point, and the case where signals are widely diffused, the light emission luminance of the light emission sub-region 36 is the same. In this case, in the case where the variance value Dv of position is small as in the case where the signals are concentrated on one point, a gain characteristic line with a steep gradient such as the gain characteristics G1A and G1B described in the above embodiment is preferably used. In other words, for example, in the case where the barycentric position is at the center of a certain light emission sub-region 36, only the light emission sub-region 36 is turned to a light-on state (gain α=1.0), and an adjacent light emission sub-region 36 does not emit light (is turned to a light-off state). Then, when an object moves and the barycentric position reaches a boundary between the light emission sub-regions 36, the adjacent light emission sub-regions 36 emit light with half the light emission luminance when the barycentric position is at the center (each gain α=0.5). Therefore, as described in the above embodiment, a reduction in power consumption is achievable while improving visual quality when a white point moves.

On the other hand, in the case where the variance value Dv of position is large (signals are widely diffused in the light emission sub-region 36) when the barycentric position in the partitioned picture is at the center of the light emission sub-region 36, some of signals may be already present around the boundary between the light emission sub-regions 36. In this case, even though an object (signals) slightly moves, some of signals move to an adjacent light emission sub-region 36; therefore, at this time, the adjacent light emission sub-region 36 also emits light to cause a decline in display quality.

Therefore, as in the case of the modification, the light-emission pattern signal BL1 is generated with use of the variance value Dv of position in addition to the barycentric position in the partitioned picture. More specifically, when the gradient of the gain characteristic line is allowed to be gentler as the variance value Dv of position increases, even in the case where the variance value Dv of position is large as described above (in the case where signals are widely diffused in the light emission sub-region 36), such a decline in display quality is preventable.

Other Modifications

Although the present disclosure is described referring to the embodiment and the modifications, the disclosure is not limited thereto, and may be variously modified.

For example, in the above-described embodiment and the like, the case where the backlight includes the red LED, the green LED and the blue LED as light sources is described. However, in addition to them (or instead of them), the backlight may include a light source emitting light of another color. For example, in the case where the backlight is configured of light sources of four or more colors, a color reproduction range is expanded, and more various colors are allowed to be reproduced.

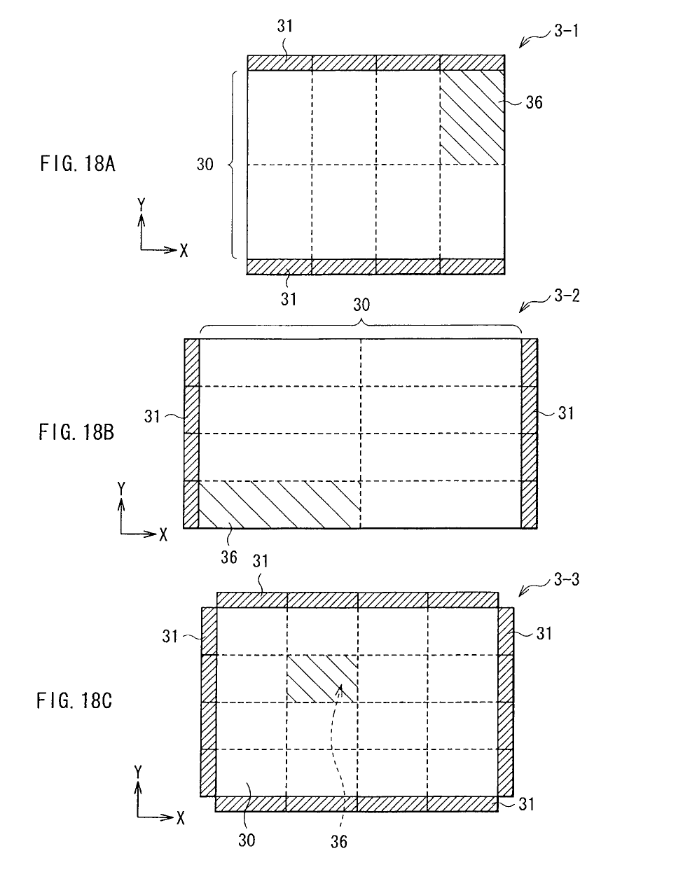

Moreover, in the above-described embodiment and the like, the case where the backlight 3 is a so-called direct-type backlight (light source section) is described as an example; however, the disclosure is applicable to a so-called edge-light type backlight such as backlights 3-1 to 3-3 illustrated in FIGS. 18A to 18C. More specifically, the backlights 3-1 to 3-3 each includes, for example, a rectangular light guide plate 30 forming a light emission plane and a plurality of light sources 31 arranged on a side surface of the light guide plate 30 (a side surface of the light emission plane). More specifically, in the backlight 3-1 illustrated in FIG. 18A, a plurality of (four in this case) light sources 31 are arranged on each of a pair of facing side surfaces (upper and lower side surfaces) in the rectangular light guide plate 30. In the backlight 3-2 illustrated in FIG. 18B, a plurality of (four in this case) light sources 31 are arranged on each of a pair of facing side surfaces (right and left side surfaces) in the rectangular light guide plate 30. In the backlight 3-3 illustrated in FIG. 18C, a plurality of (four in this case) light sources 31 are arranged on each of two pairs of facing side surfaces (upper, lower, right and left side surfaces) in the rectangular light guide plate 30. In the backlights 3-1 to 3-3 with such configurations, a plurality of light emission sub-regions 36 which are controlled separately from one another are formed on the light emission plane of the light guide plate 30.

In addition, the processes described in the above-described embodiment and the like may be performed by hardware or software. In the case where the processes are performed by software, a program forming the software is installed in a general-purpose computer or the like. Such a program may be stored in a recording medium mounted in the computer in advance.

The present application contains subject matter related to that disclosed in Japanese Priority Patent Application JP 2010-095313 filed in the Japan Patent Office on Apr. 16, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display comprising:
a light source section including a plurality of light-emission subsections which are controlled separately from one another;
a liquid crystal display panel modulating, based on an input picture signal, light emitted from each of the light-emission subsections in the light source section to display pictures; and
a display control section including a partitioning-drive processing section which generates a light-emission pattern signal and a partitioning-drive picture signal based on the input picture signal, the light-emission pattern signal representing a two-dimensional pattern formed from lighting light-emission subsections in the light source section, the display control section performing a light-emission drive on each of the light-emission subsections in the light source section based on the light-emission pattern signal and performing a display-drive on the liquid crystal display panel based on the partitioning-drive picture signal,
wherein the partitioning-drive processing section determines, based on the input picture signal, a barycentric position in a partitioned picture corresponding to each of the light-emission subsections, and generates the light-emission pattern signal and the partitioning-drive picture signal based on the barycentric position in the partitioned picture.

2. The liquid crystal display according to claim 1, wherein
the partitioning-drive processing section performs a predetermined resolution reduction process on the input picture signal to generate a lowered-resolution picture signal having a resolution corresponding to an array of the light-emission subsections, performs a gain correction on the lowered-resolution picture signal with use of a gain value which is determined in accordance with the barycentric position, and then generates the light-emission pattern signal based on a gain-corrected lowered-resolution picture signal as the resultant of the gain correction.

3. The liquid crystal display according to claim 2, wherein
a gain characteristic, representing a relationship between the barycentric position and the gain value, exhibits a tendency in which the gain value decreases as the barycentric position goes away from a center of each of the light-emission subsections.

4. The liquid crystal display according to claim 3, wherein
the gain value is 1.0 at the center of each of the light-emission subsections, and is 0.5 at a boundary between adjacent light-emission subsections.

5. The liquid crystal display according to claim 3, wherein
the partitioning-drive processing section further determines, based on the input picture signal, a variance value of position in picture for each of the partitioned pictures, and generates the light-emission pattern signal with use of the variance value of position in addition to the barycentric position.

6. The liquid crystal display according to claim 5, wherein
the partitioning-drive processing section adjusts, in accordance with the variance value of position, a gradient of a gain characteristic line representing the gain characteristic.

7. The liquid crystal display according to claim 6, wherein
the partitioning-drive processing section allows the gradient of the gain characteristic line to be steeper as the variance value of position decreases, and to be gentler as the variance value of position increases.

8. The liquid crystal display according to claim 1, wherein
the light source section is configured of a light source of a direct type or an edge-light type.
